(19) United States
(12) Patent Application Publication
(10) Pub. No.: US 2024/0144903 A1
(43) Pub. Date: May 2, 2024

(54) ELECTRONIC CYMBAL WITH MULTIPLE SENSORS

(71) Applicant: InMusic Brands, Inc., Cumberland, RI (US)

(72) Inventor: Daniel Recchia, East Providence, RI (US)

(21) Appl. No.: 18/496,754

(22) Filed: Oct. 27, 2023

Related U.S. Application Data
(60) Provisional application No. 63/419,801, filed on Oct. 27, 2022.

(51) Int. Cl. G10H 3/14; G10D 13/06; G10D 13/10; G10H 1/00

(52) U.S. Cl. CPC G10H 3/146; G10D 13/06; G10D 13/26; G10H 1/0008; G10H 3/143; G10H 2220/525

(57) ABSTRACT

An electronic cymbal for use with an electronic drum module includes two edge sensors, each disposed at a different angle, and aligned with a striking surface of the electronic cymbal perimeter edge, allowing the cymbal to be placed at any height and/or left/right position in the drum kit while still responsive to any striking technique or striking angle with sensitivity and accuracy. In addition, the cymbal striking surface is form fitted over cymbal frame, thereby minimizing the amount of striking surface material needed and allowing the cymbal frame and striking surface much more closely resemble the contours of a real acoustic cymbal.

### CROSS-REFERENCE TO RELATED APPLICATIONS

This application claims the benefit of U.S. Provisional Application No. 63/419,801 filed Oct. 27, 2022, which is herein incorporated by reference.

### FIELD OF TECHNOLOGY

The disclosure relates to electronic percussion instruments, and, more particularly, to electronic cymbals used with electronic drum kits.

### BACKGROUND

Electronic drum kits are designed as alternatives and/or substitutions to real acoustic drum kits. Electronic drum kit components, e.g. drum, cymbal, bass drum, etc., typically implement various sensors to electronically capture information about the performance. This performance information is then sent to a digital “drum module” which receives the electronic signals from kit components and processes the performance information and converts it into a musical output, typically by playing back percussion sound samples.

It is desirable for the form factor and system performance of an electronic percussion instrument to closely resembles that of the acoustic hardware it is trying to replace or supplement while at the same time doing so with minimal artifacts and various inaccuracies that will affect the drummer's “suspension of disbelief”, or general comfort level while playing.

A first problem with the playability of common electronic cymbal designs is that the reasonably playable area is limited to a fraction of the entire cymbal surface, due to an insufficient number and/or placement of sensors. An acoustic cymbal is a circular playing surface mounted on a stand at the cymbal center point. A drummer is physically able to strike an acoustic cymbal all the way around the surface and get some meaningful acoustic sound. Historically, electronic cymbals have had limited numbers of sensors resulting in a limited area of the cymbal that can accurately pick up velocity and location. Often single piezos are used, resulting in uneven response around the surface. Also, location sensors only cover a percentage of the surface (basically the “player side” of the cymbal). To ensure the drummer does not accidentally play in an area not sufficiently covered by sensors, the cymbal must be affixed to the stand with some mechanical method of preventing it from rotating or swinging naturally. Effectively, in most prior art electronic cymbals, the optimal sensor area always faces the drummer.

Accordingly, a need exists for an electronic cymbal whose shape, sensitivity and mountability more closely resembles that of an acoustic cymbal.

A second problem common in electronic cymbal designs is that locational sensors are commonly switch type sensors that do not pick up vibration, but instead, must be depressed thus closing the circuit and sending a readable voltage change to processing logic. Locational sensors are typically disposed on the top side of the cymbal frame underneath a rubber layer which constitutes the actual playing surface. Unfortunately, the location sensors in many prior art electronic cymbals do not adequately accommodate different playing techniques—particularly different angles of attack from the drummer's stick. If a drummer's stick is approaching the edge area from an angle that is perpendicular to the locational sensor, the stick must now travel through a thicker section of rubber, and at angle that does not depress the rubber to properly close the locational sensor. As a result, the locational sensor is not activated and a “wrong” hit is registered. When a “wrong” signal is processed by the accompanying electronic drum module, the result may be playing an unexpected or wrong sound, playing a sound at an unexpected volume level, or other audio artifacts related to the drum module's trigger signal processing being unable to analyze the signal.

Accordingly, another need exists for an electronic cymbal having a playing surface precisely aligned to the locational sensors in a way that optimized sensitivity to the various drummer's strikes.

A further need exists for an electronic cymbal having a uniform distance between the rubber striking surface and the locational sensors.

### SUMMARY

According to one aspect of the disclosure, an electronic comprises a plurality of sensors placed in the electronic cymbal body and proximate the edge of the cymbal body. In embodiments, two separate strips of sensors may be placed around all or a portion of the circumference of the cymbal body edge. In embodiments, each of the two sensor strips are placed at separate, different angles relative to one another. In embodiments, the two senor strips are each placed at different angles and generally parallel to the most common stick angles at which a drummer will strike the cymbal edge. The striking surface is also “form fitted” to these sensors, rather than being formed in a sharp edge termination which can compromise proximity to and activation of the edge sensors.

According to one aspect of the disclosure, an electronic cymbal comprises multiple piezo electric and locational sensors evenly around the full 360 degree surface area of the electronic cymbal, allowing the electronic cymbal to be mounted without any restriction, and for a much wider (and more realistic) variety of playing styles to be properly detected.

According to another aspect of the disclosure, two edge sensors, each at a different angle, and are disposed and aligned with a striking surface of the electronic cymbal perimeter edge, allowing the cymbal to be placed at any height and/or left/right position in the drum kit while still responsive to any striking technique or striking angle with sensitivity and accuracy.

According to another aspect of the disclosure, the problem of bell locational sensor sensitivity is addressed by “form fitting” the striking surface and cymbal frame, thereby minimizing the amount of striking surface material needed (and thus impeding hits). An additional advantage of this approach is that the cymbal housing and striking surface much more closely resemble the contours of a real acoustic cymbal, and thus can follow the familiar physical movements of a real cymbal more closely.

According to yet another aspect of the disclosure, an electronic cymbal comprises: a cymbal body defining an exterior striking surface having a perimeter edge; a first sensor disposed proximate the perimeter edge at a first angle; and a second sensor disposed proximate the perimeter edge at a second angle different from the first angle. In embodiments, at least one of the first and second sensors are disposed within the cymbal body interiorly of the striking surface. In embodiments, the perimeter edge has a circumferential shape and one or both of the first and second sensors has a circumferential shape. In embodiments, the first sensor may be either electrically insulated from or electrically coupled to the second sensor.

According to still another aspect of the disclosure, an electronic cymbal comprises: an exterior striking surface having a thickness and defining a perimeter edge profile and a bell profile; an interior frame disposed beneath the exterior striking surface and substantially mimicking the perimeter edge profile and the bell profile of the exterior striking surface; a first sensor disposed intermediate the exterior striking surface and interior frame and proximate the perimeter edge profile; and a second sensor disposed intermediate the exterior striking surface and interior frame and proximate the bell profile, wherein the thickness of the exterior striking surface proximate the first and second sensors is substantially uniform. In embodiments, the electronic cymbal further comprises a third sensor disposed intermediate the exterior striking surface and interior frame and proximate the perimeter edge profile. In embodiments, the perimeter edge has a circumferential shape and one or both of the first and second sensors has a circumferential shape. In embodiments, the first sensor may be either electrically insulated from or electrically coupled to the third sensor.

### BRIEF DESCRIPTION OF THE DRAWINGS

For a more complete understanding of the present disclosure and the advantages thereof, reference is now made to the following description taken in conjunction with the accompanying drawings in which like reference numerals indicate like features and wherein:

FIG. 1 is a side cross-sectional view of the electronic cymbal system in accordance with the disclosure;

FIG. 2 is a partial, side cross-sectional view of the electronic cymbal of FIG. 1 illustrating the relationship of the dual edge sensors to the cymbal striking surface and frame in accordance with the disclosure;

FIG. 3 is a top view of the electronic cymbal of FIG. 1 with the striking surface removed illustrating the frame and bell and edge sensors in accordance with the disclosure;

FIG. 4 is a partial, side cross-sectional view of the electronic cymbal of FIG. 1 illustrating the relationship of the bell sensor to the cymbal striking surface and frame in accordance with the disclosure;

FIG. 5 illustrates conceptually a perspective top view of the cymbal mount of FIG. 1 in accordance with the disclosure; and

FIG. 6 illustrates conceptually a perspective bottom view of the cymbal mount of FIG. 1 in accordance with the disclosure.

FIG. 7 illustrates a block diagram of a drum module that receives a signal from the disclosed cymbal component and processes the signal through various stages.

### DETAILED DESCRIPTION

The present disclosure will be more completely understood through the following description, which should be read in conjunction with the drawings. In this description, like numbers refer to similar elements within various embodiments of the present disclosure. The skilled artisan will readily appreciate that the methods, apparatus and systems described herein are merely exemplary and that variations can be made without departing from the spirit and scope of the disclosure. The terms comprise, include, and/or plural forms of each are open ended and include the listed parts and can include additional parts that are not listed. The term and/or is open ended and includes one or more of the listed parts and combinations of the listed parts.

The present disclosure describes an electronic cymbal that includes a cymbal body defining an exterior striking surface having a perimeter edge; a first sensor disposed proximate the perimeter edge at a first angle; and a second sensor disposed proximate the perimeter edge at a second angle different from the first angle.

In some aspects, the electronic cymbal includes a substantially rigid interior frame.

In some aspects, at least one of the first and second sensors is disposed on the frame interiorly of the striking surface.

In some aspects, the perimeter edge has at least a partially arcuate shape and at least one of the first and second sensors has at least a partially arcuate shape.

In some aspects, the perimeter edge has a circumferential shape and one of the first and second sensors has a circumferential shape.

In some aspects, the exterior striking surface further defines a bell profile and wherein a third sensor is disposed proximate bell profile.

In some aspects, the electronic cymbal is, in combination with, and operatively coupled to, an electronic drum module responsive to a signal from one of the first and second sensors and configured for triggering playback of a sound associated with the one of first and second sensors.

In some aspects, the first sensor is electrically insulated from the second sensor.

In some aspects, the first sensor is electrically coupled to the second sensor.

In an exemplary aspect, an electronic cymbal includes an exterior striking surface having a thickness and defining a perimeter edge profile and a bell profile; an interior frame disposed beneath the exterior striking surface and substantially mimicking the perimeter edge profile and the bell profile of the exterior striking surface; a first sensor disposed intermediate the exterior striking surface and interior frame and proximate the perimeter edge profile; and a second sensor disposed intermediate the exterior striking surface and interior frame and proximate the bell profile, wherein the thickness of the exterior striking surface proximate the first sensor and the second sensor is substantially uniform.

In some aspects, a third sensor is disposed intermediate the exterior striking surface and interior frame and proximate the perimeter edge profile.

In some aspects, the first sensor and the third sensor are disposed in different planes relative to the interior frame.

In some aspects, the electronic cymbal is, in combination with, and operatively coupled to, an electronic drum module responsive to a signal from one of the first sensor and the third sensor and configured for triggering playback of a sound associated with the one of first and second sensors.

In some aspects, the first sensor is electrically insulated from the second sensor.

In some aspects, the first sensor is electrically coupled to the second sensor.

In some aspects, the perimeter edge has a circumferential shape and one of the first sensor and the third sensor has a circumferential shape.

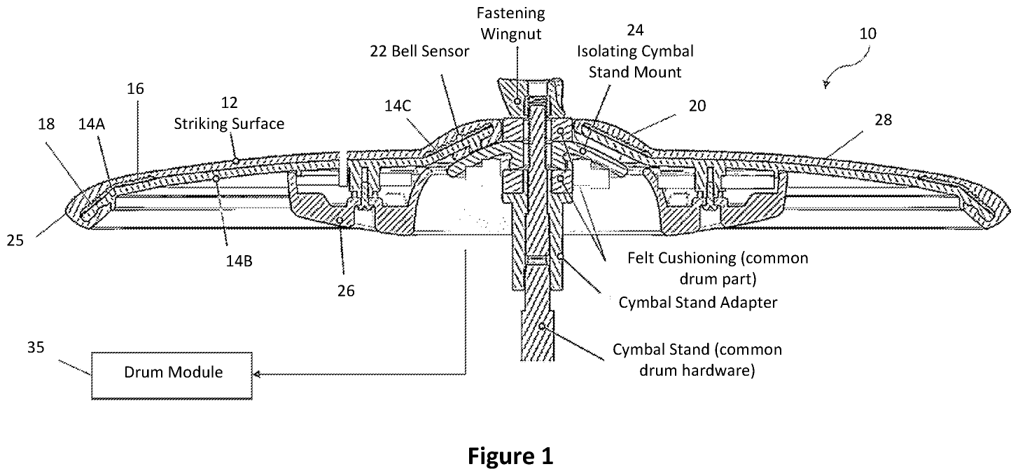

FIGS. 1-6 illustrate embodiments of an electronic cymbal 10 comprising a striking surface 12, frame 14, upper edge sensor 16, lower edge sensor 18, bell sensor 22, cymbal mount 24, and bottom cover 26, as illustrated. In embodiments, cymbal 10 has a circular or circumferential shape similar to a traditional acoustic cymbal with a perimeter edge 25 surrounding an intermediate bow portion 23 which further surrounds a central bell portion 20, as illustrated in FIGS. 1-4. In embodiments, cymbal 10 may be less than circular but may have a semi-circular or arcuate shape will still implementing most of the cymbal features disclosed.

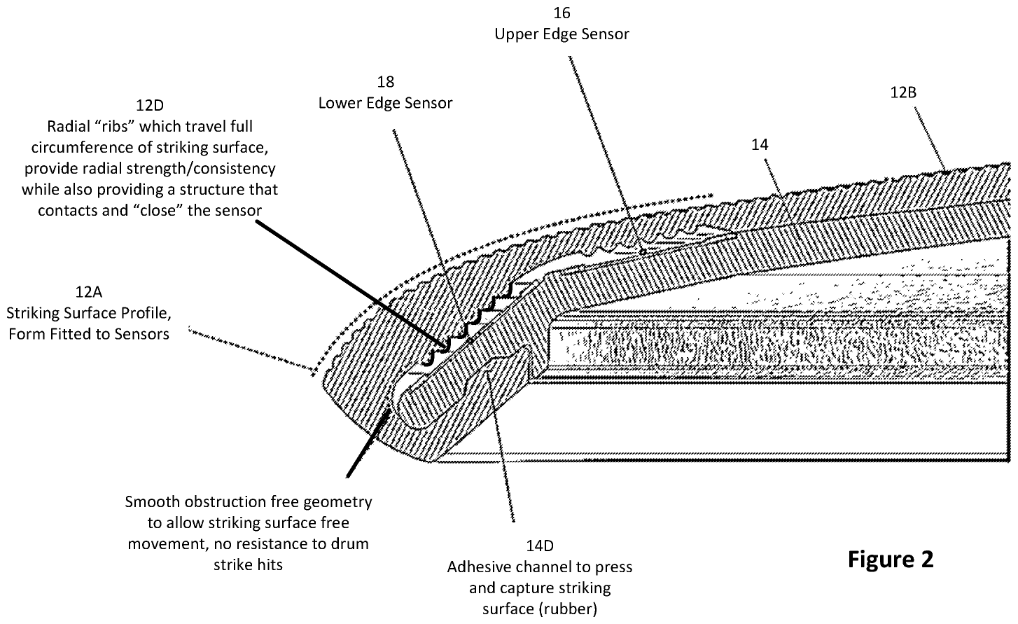

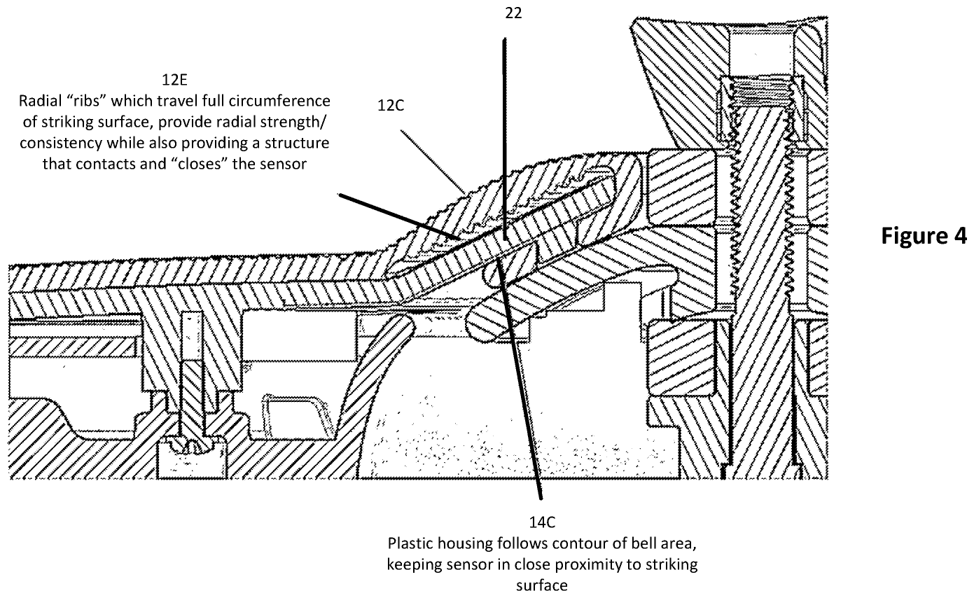

In embodiments, striking surface 12 may be made from natural or synthetic rubber or other material elastomeric properties and functions as the surface upon which stretched to the cymbal are delivered. Striking surface 12 may have a thickness of approximately 3.5 mm, but varies in certain areas, most notable being slightly thicker towards perimeter edge portion 12A, over the bow portion 12B thereof and bell portion 12C, as illustrated in FIGS. 2 and 4, respectively.

In embodiments, frame 14 may be implemented with any number of substantially rigid materials, including variety of plastics and polymers, and has a shape which substantially mimics the features of the cymbal body 10 including an angled perimeter edge portion 14A, a slightly curved bow portion 14B, and a bell portion 14C, as illustrated. Frame 14 further defines an adhesive channel under perimeter edge portion 14A into which an end of striking surface 12 with complementary mating features may be accommodated to secure striking surface 12 to frame 14 at the perimeter edge portion of the cymbal body. Similarly, frame 14 further defines features beneath bell portion 14C into which an end of striking surface 12 with complementary mating features may be accommodated to secure striking surface 12 to frame 14 at the bell portion of the cymbal body.

In embodiments, bottom cover 26 may be implemented with an annual shaped substantially rigid housing, e.g. plastic or other public, which protects the underside of frame 14 and any printed circuit board for electronic components disposed thereunder. Bottom cover 26 may be secured to frame 14 investors or other fastening elements, as illustrated in FIGS. 1 and 4.

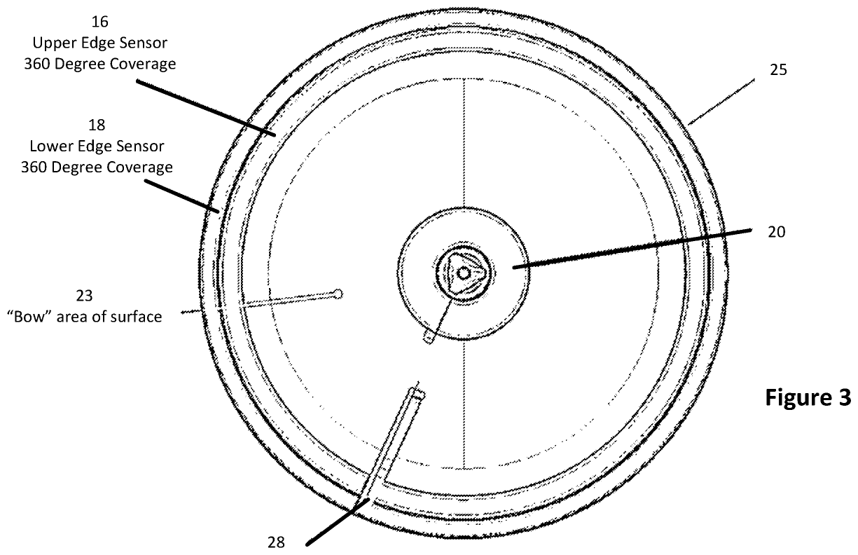

FIG. 2 illustrates conceptually a partial, side cross-sectional view of the electronic cymbal 10 of FIG. 1 with dual-edge sensors illustrating the perimeter edge profile of the cymbal 10 and the relationship of the frame 14 to the striking surface 12 and sensors 16 and 18. The perimeter edge and bill profiles of the circumferential-shaped cymbal 10 allows drummers to experience very high quality sensitivity performance regardless of where the cymbal is placed in relation to their body, e.g. eye level, torso level, left/right side, etc . . . , while also allowing accurate detection of hits to the perimeter edge's regardless of how soft or hard the user strikes. In embodiments, both sensors 16 and 18 can have their respective signals sent to the drum module 35 separately so different sounds/effects can be assigned to each section, or coupled together to effectively increase the coverage of a single edge area. The rubber striking surface 12 is form fitted over both of sensors 16 and 18, allowing very close proximity of the rubber thickness of the striking surface to the sensors, so the drummer requires very little force to active either sensor. The bottom side of striking surface 12 contains a set of multiple radial ribs 12D above each sensor 16 and 18 which serve as the point of contact with that sensor. In embodiments, were each of each sensor 16 and 18 extend the entire circumference of cymbal 10, radial ribs 12D co-extend the entire circumference of cymbal 10, as illustrated in FIG. 3, or, alternatively, to the extent of their respective sensor. Similarly, the bottom side of striking surface 12 contains a set of multiple radial ribs 12D above each sensor 16 and 18 which serve as the point of contact with that sensor. In embodiments, were each of each sensor 16 and 18 extend the entire circumference of cymbal 10, radial ribs 12D co-extend the entire circumference of cymbal 10, as illustrated in FIG. 3, or, alternatively, to the extent of their respective sensor.

FIG. 3 is a top view of the electronic cymbal of FIG. 1 without the striking surface illustrating the frame 14 and bell sensor 22 and edge sensors 16 and 18. In embodiments, edge sensors 16 and 18 and bell sensor 22 extend the entire 360 degree shape of the circumferential cymbal 10. Edge sensors 16 and 18 may be electrically isolated or coupled together at the point of routing through the frame 14 and to a printed circuit board (not shown) thereunder which manages the signal(s) as needed and communicates with drum module 35 via a cabled output, as described elsewhere herein.

In embodiments, upper edge sensor 16 and lower edge sensor 18 and bell sensor 22 may be implemented with any number of current commercially available resistance type thin film pressure sensors. Such sensors typically comprise a flexible, tape-like film substate having edge conductors deposited thereon and extending along opposite edges thereof and an electrically conductive material disposed intermediate the edge conductors. In embodiments, the electrically conductive material intermediate the edge conductors may be operatively coupled to only one of the edge conductors. In embodiments, the electrically conductive material intermediate the edge conductors may be deposited in a pattern of closely spaced but separated extensions, for example arranged in an interdigitating manner, which may be electrically coupled together upon application of pressure thereto. FIG. 2 illustrates a side cross-sectional view of upper edge sensor 16 and lower edge sensor 18, while FIG. 4 illustrates a similar view of bell sensor 22. FIG. 3 illustrates a is a top view of the electronic cymbal 10 with the striking surface removed illustrating the frame and bell sensor 22 and edge sensors 16 and 18 exposed. In embodiments, upper edge sensor 16 and lower edge sensor 18 and bell sensor 22 are implemented to be sensitive to very light strikes thereon, but still have durability to withstand repeated strikes.

Referring to FIG. 4, bell sensor 22 is mounted on frame area 14B which follows the contour of the striking surface 12 at bell 20 very closely, again keeping close proximity to allow maximum sensitivity to soft hits. Like the edge sensor areas 12C, the bottom side of striking surface 12 contains a set of multiple radial ribs above bell sensor 22 which serve as the point of contact with sensor 22, and extend the entire circumference of the bell profile portion of the cymbal or at least the extent of sensor 22. Also like the edge sensors, the bell sensor may be routed towards the center, through the plastic housing to reach a printed circuit board.

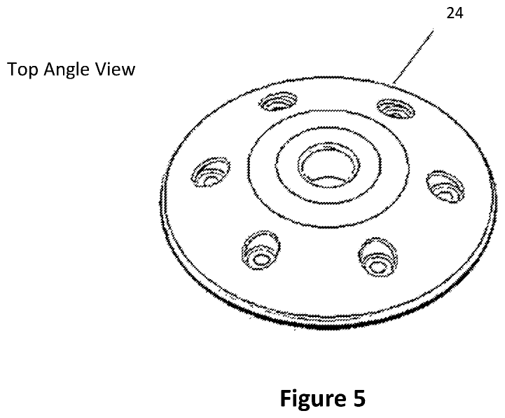

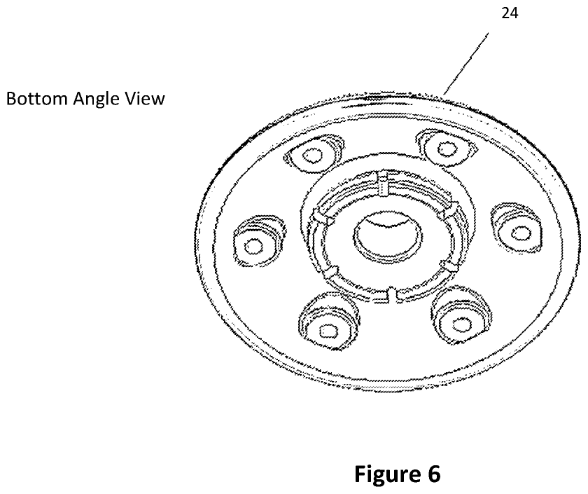

Referring to FIGS. 5 and 6, cymbal mount 24 may be made of a rubber or other elastomeric material that can absorb vibrations to and from the cymbal stand hardware, and also provide a slight bit of flexibility to retain natural cymbal movement while being hit. Because the bell sensor area is contoured upwards and substantially parallel with the striking surface, the cymbal mount 24 is designed to allow improved vibrational isolation and improved freedom of physical movement when the cymbal is hit. As illustrated in FIG. 1, cymbal mount 24 defines a central aperture for receiving a traditional cymbal stand and is mounted between a cymbal stand adapter and mounting wing nut with felt pads directly adjacent to the cymbal mount top and bottom surfaces.

FIG. 1 illustrates conceptually the interconnection between cymbal 10 and 15 drum module 35. Power to cymbal 10 may be provided by drum module 35, typically through a ¼″ TRS cable or other suitable electrical connection. The drum module 35 detects when cymbal 10 is connected. Various calibration features are available to the user for adjusting the various cymbal sounds occur. A user interface on drum module 35 may guide the user to find these sounds intuitively, based on physically using the cymbal and hearing sonic feedback. In embodiments, drum module 35 may be responsible to detect a wide variety of artifacts and “false” events. A number of these artifacts rely on the accurate detection of a strike to the cymbal. The drum module 35 identifies and possibly rejects false electronic cymbal trigger events using one or more filter algorithms which interpolate the signal from the cymbal 10.

The signal from cymbal 10, as provided to sound engine of the drum module 35, enables the drum module 35 via firmware to create seamless transitions between audio samples. In embodiments, drum module 35 may also provide power to cymbal 10, typically the via a TRS cable or other connection.

The disclosed cymbal 10 simulates the “feel” of a real cymbal to create the realistic physical feeling that drummers normally use with acoustic drum kits. Cymbal 10 can accommodate a wide range of variables, for example, drummers have a wide variety of cymbal playing techniques, some of which can be quite violent. In addition, cymbal stand manufacturers have a wide variety of designs, and manufacturing tolerances. Drummers are responsible to assemble their stand to a degree, and various missing pieces or mal-adjustment can make all of the above even less consistent.

The disclosed features of the electronic cymbal 10 may be applied/embodied equally across multiple electronic cymbal products of different sizes. Commonly, both acoustic and electronic cymbals come in different sizes and for different purposes, e.g. diameters of 12″, 14″, 16″, 18″. All inventions discussed here can be applied to any diameters that will be used in common e-drum kit configurations.

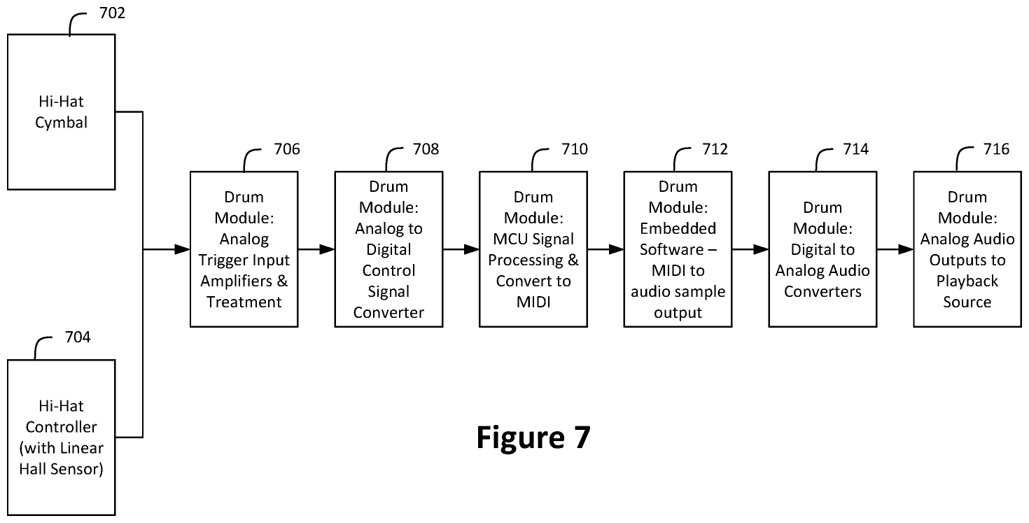

FIG. 7 illustrates a block diagram of a drum module that receives a signal from the disclosed cymbal component and processes the signal through various stages.

Stage 702 indicates a hi-hat stand mounted cymbal trigger system. The single TRS cable connection from the cymbal provides two voltage signals:
One which captures how hard the drummer is hitting the cymbal (via sensors/transducers designed to capture signal strength)
One which captures a location on the cymbal where the drummer has hit the cymbal (via on/off, switch type sensors)

These two signals are sent discretely on one cable to stage 706, which includes the trigger input connections of the drum module. Stage 704 indicates a hi-hat stand mounted controller mechanism. The single TRS cable connection from the controller provides one voltage signal: A variable voltage which captures the height of the cymbal trigger relative to the controller, effectively tracking the hi-hat stand's pedal mechanism movement.

This single signal is sent discretely on one cable to stage 706.

Stage 706 represents the analog inputs of the drum module, which receive the voltages from stages 702 and 704. All signals are treated and prepared for stage 708, which is the analog to digital converter of the drum module. Once the stage 702/704 signals are converted to raw digital streams, it is sent to a microcontroller (MCU). It should be noted that when the diagram shows two arrows between the modules, it indicates that the stages 702 and 704 signals are still discrete.

Stage 710 is configured for a significant amount of processing and filtering of stage 702/704 signals, and eventually converts this into a single MIDI data stream.

The stage 702 cymbal trigger signal is run through MCU firmware algorithms configured to measure the velocity (e.g., strength/level). The algorithms are further configured to measure the hit location via the switch sensors. The algorithms are further configured to comprehensively filter out noise that causes unwanted trigger events. For example, a trigger event may involve a drummer striking the cymbal once, but multiple strikes being falsely detected by the module. Another trigger event may involve a drummer striking one sensor location, but the wrong location being triggered. The algorithms are further configured to compare these two signals to create a single MIDI output signal comprised of: (a) a MIDI velocity value (e.g., how hard it was hit), a MIDI Note value (e.g., where it was hit), and a MIDI aftertouch value (e.g., if the cymbal was grabbed by the drummer, causing a “choke” or “mute” event—simulating a drummer grabbing a real cymbal to stop the resonance).

The strength of the hit/voltage is converted to a common MIDI velocity value between 0-127 (and optionally, a higher resolution 0-4096 value). When a strike event occurs, stage 710 simultaneously looks for the switch/location sensor status. If no switch sensors are active, a MIDI note is sent indicating what is referred to as a cymbal “bow” zone event. If the sensor on the edges of the cymbal are detected, a MIDI note is sent indicating a cymbal “edge” zone event. If the cymbal “bell” sensor is hit, a MIDI note is sent indicating a cymbal “bell” zone event. Finally, if the user physically grabs the edge sensors for more than a threshold amount of time (e.g., X milliseconds defined by developer), this registers a “choke” event, which comes in the form of a MIDI aftertouch message. While this aftertouch event is active, the drum module's sound generator will typically play a muted or choked sound.

In some aspects, the cymbal trigger signal processing in the MCU is coupled with a hi-hat. For the hi-hat type system, there is an additional signal from the stage 704 controller, which is processed and compared with the cymbal trigger signal to complete the performance capturing of the drummer's hi-hat. Like the stage 702 signal, the stage 704 signal is similarly treated by algorithms in the MCU firmware as follows:

Measure the voltage of the controller to indicate the height of the cymbal trigger on the hi-hat stand, and convert that to a variable MIDI CC value from 0-127 (also capable of 0-4,096 if needed)

Measure the upwards or downwards velocity and acceleration of the above controller position, which is then used to determine the strength of the pedal “chick” sound (simulating two cymbals of an acoustic hi-hat hitting together), and also used for several algorithms which filter out unwanted noise, for example, unwanted vibrations caused by the hi-hat stand hardware slamming against itself.

All of the information above may be used in multi-faceted, quite sensitive, and fine-tuned algorithms, which heavily rely on the accuracy of the incoming signal. This is where the excellent resolution, accuracy, and manufacturing repeatability of the hall sensor technology has incredible benefit. The physical/mechanical action and variance of a drummer's hi-hat can be so violent and diverse that an inaccurate or low resolution controller can render some unwanted noise impossible to decipher and control or isolate.

Similar to how the stage 702 signals are combined to inform the creation of one set of MIDI events, in the next stage 712, the sound generator portion of the software, is configured to take the filtered/finalized MIDI signals from stage 710 and combine them to produce the desired sound/synthesizer output.

While a single virtual cymbal may have a series of sounds or “articulations” associated with it (e.g., bow, edge, bell), a hi-hat virtual cymbal must extrapolate those three articulations into several different hi-hat controller height/positions. For example, below is a list of available articulations in a typical high quality hi-hat sound source in the drum module used with the inventions disclosed. Keep in mind, these are all sounds carefully pre-recorded in a studio or similar by positioning an actual hi-hat cymbal set and stand in various degrees of “openness,” under various striking techniques:
Bow Closed
Bow Semi-Open 1
Bow Semi-Open 2
Bow Semi-Open 3
Bow Fully Open
Edge Closed
Edge Semi-Open 1
Edge Semi-Open 2
Edge Semi-Open 3
Edge Fully Open
Edge Closed
Bell Semi-Open 1
Bell Semi-Open 2
Bell Semi-Open 3
Bell Fully Open
Pedal “Chick”
Pedal “Splash”

The above list of sounds is not indicative of any maximum; theoretically the number of different articulations is endless and only limited by the triggering system's ability to capture a performance accurately.

Essentially, the data coming from stages 702 and 704, which on stage 712 have essentially been encoded into a single event described in MIDI data, are used to precisely choose which sound from the above articulation list is accurate. Then the stage 712 software plays this sound to the stages 714 and 716 digital to analog audio converters and drum module audio outputs (a typical audio output implementation).

Further, the drum module's software at stage 712 can also interpret the incoming MIDI data to apply certain DSP operations on the sounds being played back. For example, when a user hits a sound corresponding to an “open” hi-hat cymbal, and then afterwards they depress the hi-hat pedal and “close” the hi-hat cymbals, the software sound engine can simulate the effect of the cymbals muting each other as they come into contact with each other. Again, such synthesis methods can be well employed to create a realistic feeling and sounding electronic drum system, especially when the accuracy and resolution of the controller and cymbal input stages are so excellent.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

At various places in the present specification, values are disclosed in groups or in ranges. It is specifically intended that the description include each and every individual sub-combination of the members of such groups and ranges and any combination of the various endpoints of such groups or ranges. For example, an integer in the range of 0 to 40 is specifically intended to individually disclose 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40, and an integer in the range of 1 to 20 is specifically intended to individually disclose 1, 2, 3, 4, 5, 6, 7, 8, 9, 10, 11, 12, 13, 14, 15, 16, 17, 18, 19, and 20. Real numbers are intended to be similarly inclusive, including values up to at least three decimal places.

As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and, accordingly, all suitable modifications and equivalents falling within the scope of the disclosure may be resorted to.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Moreover, while illustrative embodiments have been described herein, the scope of any and all embodiments include equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. An electronic cymbal, comprising:
a cymbal body defining an exterior striking surface having a perimeter edge; a first sensor disposed proximate the perimeter edge at a first angle; and
a second sensor disposed proximate the perimeter edge at a second angle different from the first angle.

2. The electronic cymbal of claim 1, further comprising a substantially rigid interior frame.

3. The electronic cymbal of claim 2, wherein at least one of the first and second sensors is disposed on the frame interiorly of the striking surface.

4. The electronic cymbal of claim 1, wherein the perimeter edge has at least a partially arcuate shape and wherein at least one of the first and second sensors has at least a partially arcuate shape.

5. The electronic cymbal of claim 1, wherein the perimeter edge has a circumferential shape and wherein one of the first and second sensors has a circumferential shape.

6. The electronic cymbal of claim 5, wherein the exterior striking surface further defines a bell profile and wherein a third sensor is disposed proximate bell profile.

7. The electronic cymbal of claim 1, in combination with, and operatively coupled to, an electronic drum module responsive to a signal from one of the first and second sensors and configured for triggering playback of a sound associated with the one of first and second sensors.

8. The electronic cymbal of claim 1, wherein the first sensor is electrically insulated from the second sensor.

9. The electronic cymbal of claim 1, wherein the first sensor is electrically coupled to the second sensor.

10. An electronic cymbal, comprising:
exterior striking surface having a thickness and defining a perimeter edge profile and a bell profile;
an interior frame disposed beneath the exterior striking surface and substantially mimicking the perimeter edge profile and the bell profile of the exterior striking surface;
a first sensor disposed intermediate the exterior striking surface and interior frame and proximate the perimeter edge profile; and
a second sensor disposed intermediate the exterior striking surface and interior frame and proximate the bell profile,
wherein the thickness of the exterior striking surface proximate the first sensor and the second sensor is substantially uniform.

11. The electronic cymbal of claim 10, further comprising;
a third sensor disposed intermediate the exterior striking surface and interior frame and proximate the perimeter edge profile.

12. The electronic cymbal of claim 11, wherein the first sensor and the third sensor are disposed in different planes relative to the interior frame.

13. The electronic cymbal of claim 11, in combination with, and operatively coupled to, an electronic drum module responsive to a signal from one of the first sensor and the third sensor and configured for triggering playback of a sound associated with the one of first and second sensors.

14. The electronic cymbal of claim 10, wherein the first sensor is electrically insulated from the second sensor.

15. The electronic cymbal of claim 10, wherein the first sensor is electrically coupled to the second sensor.

16. The electronic cymbal of claim 11, wherein the perimeter edge has a circumferential shape and wherein one of the first sensor and the third sensor has a circumferential shape.
